(19) United States
(12) Patent Application Publication
(10) Pub. No.: US 2025/0091707 A1
(43) Pub. Date: Mar. 20, 2025

(54) Container For Flight Craft, And Flight Craft Pressure

(71) Applicant: Iwaya Inc., Ebetsu-shi (JP)

(72) Inventor: Keisuke IWAYA, Ebetsu-shi (JP)

(21) Appl. No.: 18/821,357

(22) Filed: Aug. 30, 2024

(30) Foreign Application Priority Data
Aug. 30, 2023 (JP) 2023-140160

(51) Int. Cl. B64B 1/40; B64D 47/08

(52) U.S. Cl. CPC B64B 1/40; B64D 47/08

(57) ABSTRACT

A container for a flight craft is provided and comprises a main body that contains air and is airtight against an external space, and a restraining member having a cage-like structure and arranged to cover the main body, wherein the restraining member restrains a wall of the main body to generate a force that counteracts an inward to outward force that acts on the main body due to a difference between an internal and external pressure during flight. The flight craft may further comprise an adjusting mechanism that adjusts a length of a portion of the restraining member. The restraining member may be made of an elastic material.

### TECHNICAL FIELD

The present invention relates to a container for flight craft.

### BACKGROUND ART

Generally, it is desirable for flight craft that fly by buoyancy, such as balloons and airships, as well as those that fly by lift, such as airplanes and helicopters, to be lightweight, so as to attain enhanced performance in both altitude and speed.

Many flight craft are equipped with a container for carrying cargo, including people. For example, flight craft that transport passengers are equipped with a passenger container, referred to as a cabin.

To attain a lightweight flight craft, there is a need to reduce a weight of containers used in such flight craft. For example, Patent Document 1 describes a flight craft cabin that includes a main body with a wall having reinforced portions constituted of thicker band-like regions to form an airtight storage space. The cabin described in Patent Document 1 has a main body in which portions of the wall that are required to be of high strength are formed to be thicker than surrounding areas, while other portions are made thinner. In this way, it is possible to reduce a weight of the cabin described in Patent Document 1 while ensuring a necessary strength.

### PRIOR ART DOCUMENT

### Patent Document

Patent Document 1: JP2022-54387A

### SUMMARY OF THE INVENTION

### Problem to be Solved by the Invention

When a flight craft ascends to a high altitude, for example, over 10,000 meters above sea level, it may be necessary for a container of the flight craft to be made airtight to maintain an internal environment with conditions such as air pressure, close to an internal environment at ground-level.

When an airtight container ascends to a high altitude, a decrease in air pressure in external space causes a significant difference in pressure between an inside and outside of the container. This results in a force that acts inward to outward on the container walls. If the container's walls are made thin to reduce weight, they may not be able to withstand a force caused by such a pressure difference, which could lead to issues such as wall cracking.

In view of the circumstances described above, the present invention provides a means for achieving sufficient strength to withstand a pressure difference between the inside and outside of an airtight container used in flight craft that ascends to high altitudes.

### Means for Solving the Problem

This invention provides a container for a flight craft, comprising: a main body that contains air and is airtight against an external space; a restraining member having a cage-like structure and arranged to cover the main body; an adjusting mechanism that adjusts a length of a portion of the restraining member; wherein the restraining member restrains a wall of the main body to generate a force that counteracts an inward to outward force that acts on the main body due to a difference between an internal and external pressure during flight.

This invention also provides a container for a flight craft, comprising: a main body that contains air and is airtight against an external space; and a restraining member made of an elastic material having a cage-like structure and arranged to cover the main body; wherein the restraining member restrains a wall of the main body to generate a force that counteracts an inward to outward force that acts on the main body due to a difference between an internal and external pressure during flight.

### Effects of the Invention

The container according to the present invention generates a force via the restraining member to counteract an inward to outward force that acts on the container body from the inside due to a difference between an internal and external pressure when the container ascends to a high altitude. As a result, a container is provided that has sufficient strength to withstand differences between internal and external pressure.

### BRIEF EXPLANATION OF THE DRAWINGS

FIG. 1 shows an overall configuration of a flight craft according to an exemplary embodiment of the present invention.

FIG. 2 shows an exterior of the container according to the exemplary embodiment of the present invention.

FIGS. 3A to 3C are explanatory diagrams of the role of the restraining member according to the exemplary embodiment of the present invention.

FIG. 4 shows a coupling mechanism according to a modification of the exemplary embodiment of the present invention.

FIG. 5 shows a container according to a modification of the exemplary embodiment of the present invention.

### MODES FOR CARRYING OUT THE INVENTION

### [1] Embodiment

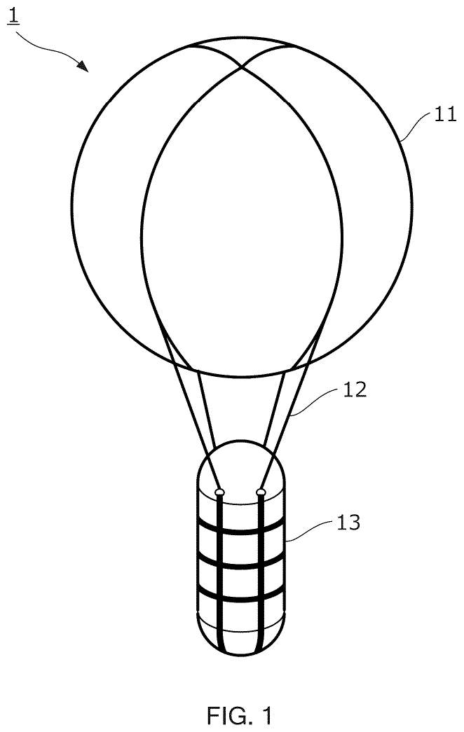

FIG. 1 shows an overall configuration of flight craft 1 according to an exemplary embodiment of the present invention. Flight craft 1 has an envelope 11, suspension cables 12, and a container 13.

Envelope 11 (an example of a buoyancy-generating member) contains a lighter-than-air gas, such as helium (hereinafter referred to as “light gas”), and generates buoyancy in air.

Multiple suspension cables 12 (four in the example shown in FIG. 1) suspend container 13 below envelope 11.

Container 13 is a container that houses objects (including people) to be transported to high altitudes during flight of flight craft 1.

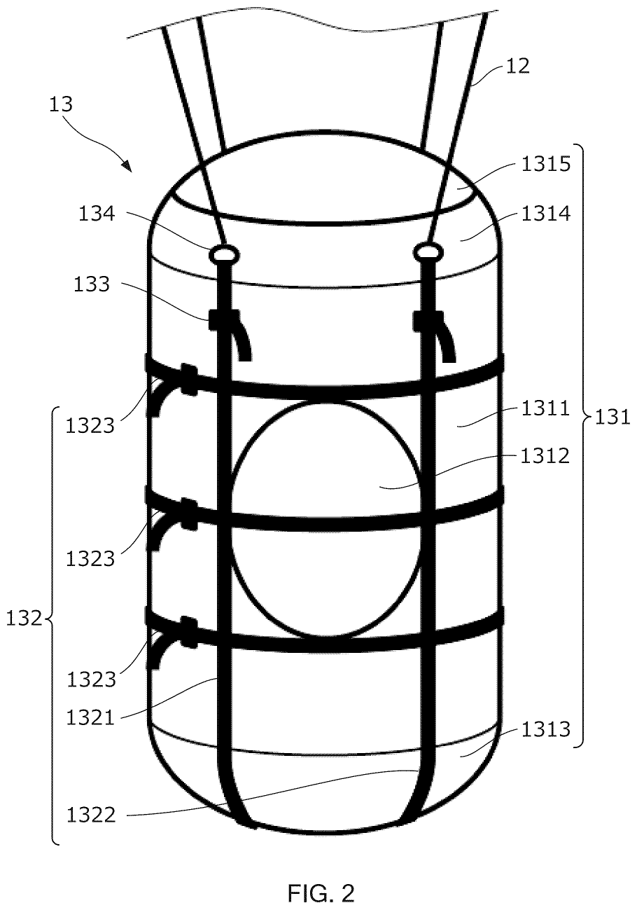

FIG. 2 shows an exterior of container 13. Container 13 has a main body 131, a restraining member 132, an adjusting mechanism 133, and connecting rings 134.

Main body 131 is the main part of container 13 that houses objects to be transported to high altitudes, and is a hollow, shell-like structure. Flight craft 1 is designed to ascend to high altitudes, for example, 10,000 meters or more above sea level. Accordingly, to maintain an internal pressure close to that at sea level even at high altitudes, main body 131 is kept securely airtight, against an external environment.

In the example shown in FIG. 2, main body 131 has a wall 1311, a window 1312, a wall 1313, a wall 1314 and a hatch 1315. Wall 1311 is cylindrical and has a vertical axis. Window 1312 is attached to cover an opening on a side of wall 1311. Wall 1313 is hemispherical and is attached to cover a lower opening of wall 1311. Wall 1314 is a hemispherical and is attached to cover an upper opening of wall 1311. Hatch 1315 is attached to cover an opening at an apex of wall 1314.

Wall 1311, wall 1313, and wall 1314 are, for example, manufactured integrally from fiber-reinforced plastic.

Window 1312 is made from, for example, polycarbonate, and allows passage of visible light with sufficient transmittance, thereby allowing people inside container 13 to see outside, and allowing external imaging by a visible light camera housed within container 13.

Hatch 1315 is manufactured from, for example, fiber-reinforced plastic reinforced with aluminum, and is operable to open and close the opening in wall 1314. For example, when hatch 1315 is open, objects (including people) can be moved in and out of container 13 through the opening in wall 1314. Hatch 1315 has sealing members (not shown in FIG. 2) and, when closed, hermetically seals main body 131 against external space.

Restraining member 132 restrains the wall structure of main body 131, i.e. wall 1311, window 1312, wall 1313, and wall 1314, by generating a force that counteracts the inward to outward force acting from the inside due to the difference in internal and external pressure during flight of flight craft 1.

Restraining member 132 is configured as a set of plural band-like members that are connected to form a cage-like structure, and arranged to be in contact with the outer surface of main body 131. Restraining member 132 is made from, for example, nylon. In the example shown in FIG. 2, restraining member 132 is comprised of band-like members 1321, 1322, 1323, 1324, and 1325. Each of band-like members 1321 and 1322 is arranged in a U-shape to be in contact with the outer surface of main body 131. Each of band-like members 1323, 1324, and 1325 is arranged in a circular shape extending horizontally to be in contact with the outer surface of main body 131.

Restraining member 132 is not fixed to main body 131 and is detachable from main body 131.

Adjusting mechanism 133 adjusts a strength of a force that counteracts the inward to outward force that acts on main body 131 due to the difference in internal and external pressure during flight of flight craft 1. In other words, adjusting mechanism 133 adjusts the strength of the force with which restraining member 132 tightens around the outside of main body 131. In the example shown in FIG. 2, adjusting mechanism 133 is provided for each of the five band-like members that comprise restraining member 132. For example, by use of a ratchet mechanism, adjusting mechanism 133 adjusts a length of a portion each of the band-like members that come into contact with main body 131.

The length each of the portion of the band-like members that comprise restraining member 132 and come into contact with main body 131 is adjusted such that a force tightening main body 131 inward is either zero or positive before commencement of flight of flight craft 1, that is, when flight craft 1 is on the ground.

Connecting rings 134 are annular components attached to ends each of band-like member 1321 and band-like member 1322. The lower ends of suspension cables 12 are also connected to connecting rings 134. As a result, main body 131 is suspended from suspension cables 12 via the restraining member 132.

When the lower ends of suspension cables 12 are directly connected to main body 131, a load of main body 131 is concentrated on areas where the lower ends of suspension cables 12 are connected. Therefore, it may be necessary to reinforce the areas where the load is concentrated, which may result in an increase in weight of main body 131. On the other hand, when main body 131 is suspended from suspension cables 12 via restraining member 132, which is arranged to cover the outside of main body 131, as in this embodiment, the load of main body 131 is evenly distributed across the areas where restraining member 132 are in contact with main body 131. Therefore, it is not necessary to reinforce main body 131, and thus there is no increase in weight of main body 131 that would otherwise be caused by reinforcement.

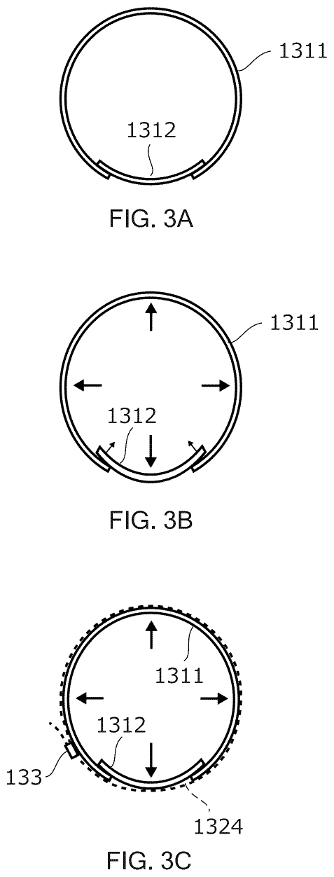

FIGS. 3A to 3C are explanatory diagrams of the role of restraining member 132. FIGS. 3A to 3C are each cross-sectional views taken along a horizontal plane at a height where band-like member 1324 is in contact with main body 131, viewed from above.

FIG. 3A shows wall 1311 and window 1312 when flight craft 1 is on the ground. In the example shown in FIGS. 3A to 3C, window 1312 is arranged to cover the opening in wall 1311 from the inside. The area where wall 1311 and window 1312 come into contact is hermetically sealed, for example, by adhesion or other bonding.

FIG. 3B shows wall 1311 and window 1312 when flight craft 1 is ascending with main body 131 uncovered by restraining member 132, resulting in a decrease in air pressure in a space external to main body 131. The decrease in external air pressure causes a force to act inward to outward from the inside of main body 131 due to the difference between the internal and external pressure. If the elasticity of window 1312 is greater than that of wall 1311, the central part of window 1312 will deform and bulge outward, as shown in FIG. 3B. As window 1312 deforms, a force acts in a direction of peeling of adhesion at the area where wall 1311 and window 1312 are adhered. As a result, a gap may form at the adhered area between wall 1311 and window 1312, posing a risk of loss of airtightness of main body 131.

FIG. 3C shows wall 1311 and window 1312 when flight craft 1 is ascending with main body 131 covered by restraining member 132, with a decrease in the air pressure in the space external to main body 131. As flight craft 1 ascends a force acts inward to outward from the inside of main body 131 due to the difference between the internal and external pressure. When restraining member 132 is arranged to cover the outside of main body 131, restraining member 132 exerts a force on main body 131 that counteracts the force acting inward to outward from the inside of main body 131 due to the difference between the internal and external pressure. Therefore, as shown in FIG. 3C, deformation of wall 1311 and window 1312 is restrained, and a risk of compromising airtightness of main body 131 is reduced as compared with a configuration that does not include restraining member 132 (see FIG. 3B).

### [2] Modifications

The above-described flight craft 1 is an exemplary embodiment of the present invention, and may be modified in various ways. Following are examples of modifications of the above-described embodiment. Two or more of the above-described embodiment and the following modifications may be combined.
(1) In the embodiment described above, restraining member 132 is designed to be detachable from main body 131. If restraining member 132 is detachable from main body 131, for example, by use of restraining member 132 with a strength suited to factors such as a maximum altitude reached during flight of flight craft 1 or a weight of a cargo contained in container 13, a total weight of flight craft 1 can be minimized.

Alternatively, restraining member 132 may be fixedly attached to main body 131. For example, a portion of restraining member 132 may be fixed to main body 131 by use of, for example, adhesion, while still allowing for adjustments via adjusting mechanism 133.
(2) In the embodiment described above, it is assumed that a strength of a force with which adjusting mechanism 133 tightens restraining member 132 against the outside of main body 131 can be adjusted. However, container 13 need not necessarily be equipped with adjusting mechanism 133. For example, if restraining member 132 is made of an elastic material and is configured to be positioned to cover main body 131, a shape and size of restraining member 132 may be pre-adjusted to exert a force that acts on the outside towards the inside of main body 131.
(3) The materials mentioned above as components of flight craft 1 are examples only, and may be varied as appropriate. For example, in the embodiment described above, wall 1311, wall 1313, and wall 1314 of main body 131 are described as being made of fiber-reinforced plastic. However, they may be made of other materials such as different types of plastic, light metals such as aluminum, or other materials. Additionally, in the embodiment described above, restraining member 132 is described as being made of nylon. However, it may be made of other materials such as different types of plastic, light metals such as aluminum, or other materials.
(4) Container 13 may be configured to have a cushioning member provided between main body 131 and restraining member 132. For example, if restraining member 132 is made of a material harder than main body 131, such as aluminum, there is a risk that when main body 131 expands outward due to the difference between the internal and external pressure, a significant force may be caused to act on main body 131 at the edge of restraining member 132, with a potential to cause damage to main body 131. If the cushioning member is provided between main body 131 and restraining member 132, potential for damage can be avoided.
(5) The shapes of the components of flight craft 1 shown in the figures or described above are examples only, and various modifications may be made to the shapes. For example, in the embodiment described above, the shape of main body 131 is described as a capsule with hemispherical walls connected to the top and bottom of a cylindrical wall. However, other shapes such as spherical, cubic, or rectangular shapes may also be used.

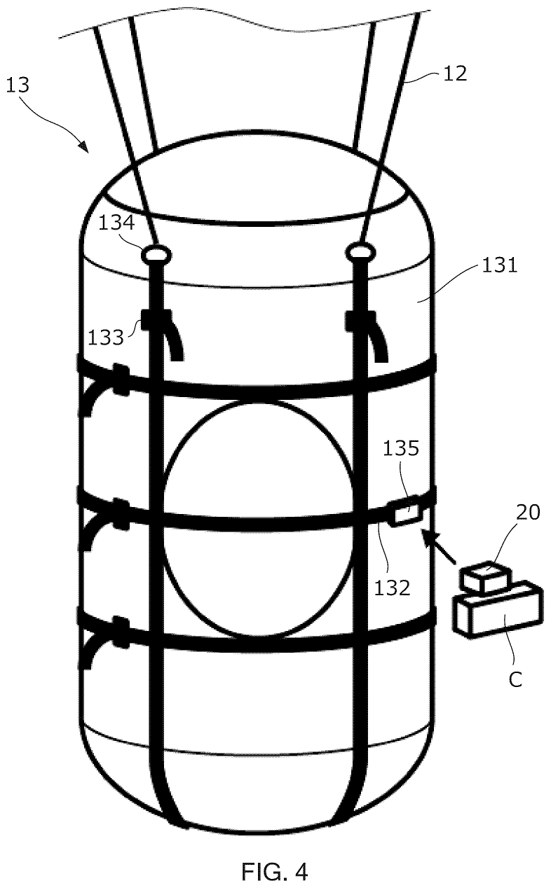

In the embodiment described above, the restraining member 132 is described as covering a portion of main body 131 while excluding wall 1314 and hatch 1315. However, for example, restraining member 132 may be of a shape that covers the entire main body 131, including wall 1314 and hatch 1315.
(6) In the embodiment described above, restraining member 132 is described as being comprised of a belt-like member. However, the form of restraining member 132 is not limited thereto, and may, for example, be comprised of a mesh-like member or a sheet-like member (such as a perforated nylon sheet) that covers a part or all of main body 131. Additionally, restraining member 132 may be comprised of a rope-like member instead of a belt-like member.
(7) Container 13 may be provided with a connecting mechanism that connects restraining member 132 to an object that is to be positioned outside main body 131. FIG. 4 shows an example of such a connecting mechanism. Connecting mechanism 135 in FIG. 4 can be detachably connected to connecting mechanism 20, which is attached to camera C (an example of an object to be positioned outside main body 131). Connecting mechanism 135 and connecting mechanism 20 can be connected to each other by methods such as screwing, engagement, or magnetism. The user can easily connect or disconnect the mechanisms by performing simple operations.

When attaching an object directly to main body 131, reinforcement may be necessary to ensure sufficient strength of main body 131 at the attachment point. On the other hand, according to this modification, the object to be positioned outside main body 131 is attached to main body 131 via restraining member 132 and connecting mechanism 135. Since a load of the object on main body 131 is evenly dispersed by restraining member 132, reinforcement of main body 131 is not required.
(8) In the embodiment described above, restraining member 132 is described as being in contact with the outer surface of main body 131. However, restraining member 132 may be positioned within the walls of main body 131.

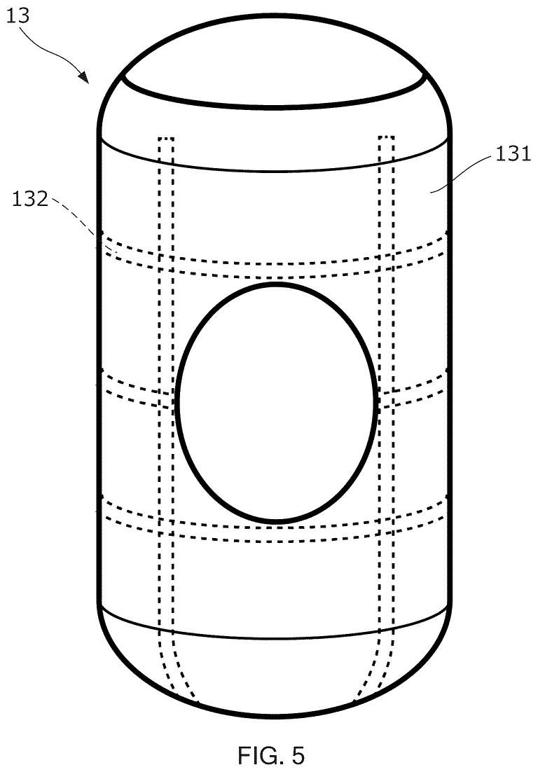

FIG. 5 shows container 13 according to this modification. In container 13 shown in FIG. 5, restraining member 132 is positioned within the walls of main body 131 in the areas indicated by the dashed lines. In this modification, the material for restraining member 132 may be, for example, nylon tape, metal plates, metal wire, or bundles of carbon fiber or glass fiber (in a case that main body 131 is made of fiber-reinforced plastic, the material may be comprised of bundles of fibers stronger than surrounding fibers, or bundles of fibers with a higher density than surrounding fibers). These materials may be embedded within the walls of main body 131 when molding main body 131.

It is of note that the wall thickness of the portion of main body 131 where restraining member 132 is located may be the same as the surrounding wall thickness or may be thicker.

Restraining member 132 may be arranged to be in contact with the inner surface of main body 131. For example, restraining member 132 may be attached from the inside so that it is in contact with the area of the inner wall surface of main body 131 as indicated by the dashed lines in FIG. 5. In this case, when main body 131 expands due to the difference between the internal and external pressure during flight, restraining member 132 generates a force that acts to restrain main body 131 from the inside, thereby counteracting the outward acting force caused by the difference between the internal and external pressure.

When restraining member 132 is arranged to be in contact with the inner surface of main body 131, it may be fixed to main body 131 by a method that results in difficulty of removal, such as adhesion, or it may be connected in a detachable manner by engagement with connecting components or other methods.

When restraining member 132 is arranged to be in contact with the inner surface of main body 131, container 13 may be equipped with adjusting mechanism 133 that adjusts the strength of the force generated by restraining member 132 to counteract the outward acting force in main body 131 caused by the difference between the internal and external pressure, similar to the case in the aforementioned embodiment.

In cases where restraining member 132 is positioned within the walls of main body 131 and is made of materials such as nylon tape, metal plates, or metal wire, or when restraining member 132 is arranged to be in contact with the inner surface of main body 131, restraining member 132 may be connected to buoyancy-generating members, such as envelope 11, via suspension cables 12, similar to the case in the aforementioned embodiment.

When restraining member 132 is positioned within the walls of main body 131, it may be configured such that the upper end of restraining member 132 is exposed outside of main body 131, and suspension cables 12 may be connected to the exposed part.

When restraining member 132 is arranged to be in contact with the inner surface of main body 131, it may be configured such that the upper end of restraining member 132 penetrates from the inside to the outside of main body 131, and suspension cables 12 may be connected to the outside exposed portion. Alternatively, a connecting component that penetrates the wall of main body 131 may be installed, with the upper end of restraining member 132 connected to the inside exposed portion of the connecting component, with suspension cables 12 connected to the outside exposed portion of the connecting component. In such cases, through-holes formed in main body 131 are hermetically sealed with sealing components or similar materials.

When restraining member 132 is arranged to be in contact with the inner surface of main body 131, container 13 may be equipped with a connecting mechanism that connects restraining member 132 to an object that is positioned inside main body 131. In this case, it is desirable for the connecting mechanism to be a component that can be detachably connected by methods such as screwing, engagement, or magnetism, to a connecting mechanism attached to the object that is to be positioned inside main body 131, similar to connecting mechanism 135 shown in FIG. 4.
(9) In the embodiment described above, flight craft 1 is assumed to be a gas balloon, but the type of flight craft 1 is not limited thereto. Flight craft 1 may be a flight craft that flies using lift generated by wings (an example of a lift-generating member), such as an airplane or helicopter, or may be a flight craft that flies using buoyancy, such as a hot air balloon, airship, or other types of buoyant flight craft other than a gas balloon.

### DESCRIPTION OF REFERENCE NUMERALS

1: Flight craft
11: Envelope
12: Suspension cables
13: container
20: Connecting mechanism
131: Main body
132: Restraining member
133: Adjusting mechanism
134: Connecting rings
135: Connecting mechanism
1311: Wall
1312: Window
1313: Wall
1314: Wall
1315: Hatch
1321: Band-like member
1322: Band-like member
1323: Band-like member
1324: Band-like member
1325: Band-like member

1. A container for a flight craft, comprising:
a main body that contains air and is airtight against an external space;
a restraining member having a cage-like structure arranged to cover the main body; and
an adjusting mechanism that adjusts a length of a portion of the restraining member;
wherein
the restraining member restrains a wall of the main body to generate a force that counteracts an inward to outward force that acts on the main body due to a difference between an internal and external pressure during flight.

2. A container for a flight craft, comprising:
a main body that contains air and is airtight against an external space; and
a restraining member made of an elastic material having a cage-like structure and arranged to cover the main body;
wherein
the restraining member restrains a wall of the main body to generate a force that counteracts an inward to outward force that acts on the main body due to a difference between an internal and external pressure during flight.

3. The container according to claim 1, wherein
the restraining member is connected by suspension cables to a buoyancy-generating member which generates buoyancy, or to a lift-generating member which generates lift.

4. The container according to claim 1, wherein
the restraining member is detachable from the main body.

5. The container according to claim 1 comprising:
a cushioning member provided between the main body and the restraining member.

6. The container according to claim 1 comprising:
a connecting mechanism that connects the restraining member and an object to be positioned outside the main body.

7. A flight craft comprising the container according to claim 1.

8. The container according to claim 2, wherein
the restraining member is connected by suspension cables to a buoyancy-generating member which generates buoyancy, or to a lift-generating member which generates lift.

9. The container according to claim 2, wherein
the restraining member is detachable from the main body.

10. The container according to claim 2 comprising:
a cushioning member provided between the main body and the restraining member.

11. The container according to claim 2 comprising:
a connecting mechanism that connects the restraining member and an object to be positioned outside the main body.

12. A flight craft comprising the container according to claim 2.
